(19) United States
(12) Patent Application Publication
(10) Pub. No.: US 2014/0348992 A1
(43) Pub. Date: Nov. 27, 2014

(54) JUICE PROCESSING

(71) Applicant: Bucher-Alimentch Limited, Auckland Region (NZ)

(72) Inventors: Nick Shea, Auckland (NZ); Chris Miller, Auckland (NZ); Tim Schofield, Auckland (NZ)

(73) Assignee: Bucher-Alimentch Limited, Auckland Region (NZ)

(21) Appl. No.: 14/279,797

(22) Filed: May 16, 2014

Related U.S. Application Data
(60) Provisional application No. 61/827,367, filed on May 24, 2013.

(51) Int. Cl. A23B 7/153

(52) U.S. Cl. CPC A23B 7/153
USPC 426/271; 99/516

(57) ABSTRACT

Method and system are provided for processing a fruit product that has been impacted by a disease. The fruit product yields a higher than normal acidity and bitterness due to the disease. The fruit product also yields a higher cloudiness than a fruit product that is not impacted by the disease. The fruit product is processed to yield a consumable product.

### PRIORITY STATEMENT

This application claims priority to Provisional Application No. 61/827,367, filed on May 24, 2013, the entirety of which is incorporated herein by reference.

### BACKGROUND

In order to prepare food products, such as citrus fruit products, for consumption and to adjust acidity and bitterness levels, one or more processes can be used in conjunction, including as an alternating process. In embodiments described below, deacidification and debitterness processes can be used with citrus fruit product, such as orange juice material, particularly where plants may be associated with conditions, such as diseases, including Huanglongbing, that may cause increased bitterness and other characteristics.

### SUMMARY

This Summary and the exemplary embodiments described here are provided to introduce a selection of concepts and are not intended to identify essential features of the claimed subject matter. As described below, exemplary embodiments discussed herein include systems and processes for addressing levels of acidity and/or bitterness associated with fruit product.

### BRIEF DESCRIPTION OF THE DRAWINGS

FIG. 1 illustrates an exemplary embodiment of vessels utilized in a deacidifying and/or debittering process;

FIG. 2 illustrates another exemplary embodiment of vessels utilized in a deacidifying and/or debittering process;

FIG. 3 is a flow diagram showing an exemplary method of implementing deacidifying and/or debittering processes;

FIG. 4 is a flow diagram showing another exemplary method of implementing deacidifying and/or debittering processes; and

FIG. 5 illustrates another exemplary embodiment of vessels utilized in a deacidifying and/or debittering process.

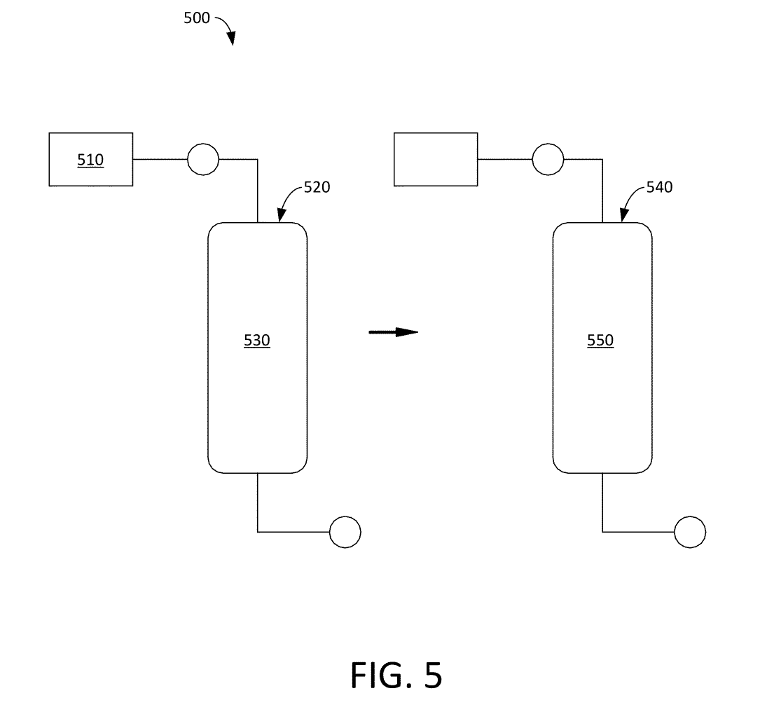

### DETAILED DESCRIPTION

Embodiments of the systems, methods and processes described below can be used to treat matter or material, such as fruit products, to make a fruit juice product with a reduced bitterness level and/or a reduced acid level. In one example, an orange juice product can be created or treated before consumption using one or more processes described herein. Juice products can be intended or desired to be better tasting through less acidity and less bitterness. Consumers of juice products may prefer juice that has been processed to have, for example, lower acidity or lower bitterness.

An originating material or starting material can include more than one component or ingredient, such as various fruit parts or portions. A citrus juice, such as orange juice, is the starting material in an embodiment. An originating fruit product may be a concentrated citrus juice, a peel juice or a pulp product, and the originating product may have been treated or processed to wash or process the fruit. In an embodiment, the fruit product may have a Brix level that indicates a level of soluble solids or sugars. A range of Brix levels are possible, based on concentration and/or other factors, including Brix levels anywhere up to 60 degrees or even higher, in some cases. Embodiments discussed herein can be used with fruit products with a variety of Brix levels, including dynamic Brix levels during processing.

Fruit products, such as an orange fruit product, that will be processed into a juice product for human consumption can contain higher levels of acidity than intended for a final, marketed fruit juice. Embodiments of the methods described here can be used to produce to reduced-acid juice. In some cases, a ratio of the Brix level to acid is used to describe reduced-acid juices, such as juices where the fruit product was deacidified at some point. In one exemplary embodiment, a Brix level to acid ratio above 15 can be associated with a reduced-acid juice or fruit product. In other cases, a lower or higher ratio can be used or intended, and a targeted ratio during a process may change based on other considerations.

A reduced- or lower-acidity fruit juice product is associated, in some examples, with removed or reduced citric acid levels and/or a higher pH value. As described below, one or more deacidifying processes or treatments can be used alone or in conjunction with one or more debittering processes. Such processes can maintain or improve flavors of fruit products, such as juices, as well as reduce some side effects associated with relatively higher acid or bitterness levels, including discomfort of consumers. These side effects include both well-known and rare physical effects of consuming relatively higher levels of acidity.

Acid and bitterness levels can vary based on the type or types of fruit product used, such as citrus fruit or non-citrus fruit, orange or grapefruit, or a combination of two or more types of fruit products. Levels can be higher or lower based on the processing of fruit products (including preprocessing), natural causes, source locations and trends, selection of products, time of year and other reasons. For example, oranges or grapefruits from different states, different parts of a single state, different countries, or subject to different weather can result in acid and/or bitterness levels, such that one or more processes to reduce these levels can be beneficial.

Fruit matter, prior to processing for consumption, can have relatively high levels of bitterness (compared to, for example, the typical levels of bitterness found in consumer fruit juice products as sold). Naturally-occurring bitterants can be present in small quantities, from a few parts per million to higher levels, such as hundreds of parts per million. Bitterants can include naringin and limonin, for example. In one specific example, limonin is present in citrus fruit, such as oranges.

An originating material or starting fruit product can indicate a fruit product that is intended to be debittered and/or deacidified prior to marketing to consumers. A starting fruit product for purposes of lowering acid and/or bitterness levels may or may not have been treated to achieve a particular Brix level or other characteristic, such as treatment to address pulp and/or other solids or matter, treatment to filter, or other processing steps prior to steps described herein. A fruit product, before or after initial processing, can include a cloud level or cloudiness. Various causes of cloud in a fruit product exist.

In one example, a fruit product has a higher cloud level due to a disease, such as a greening disease affecting one or more plants, such as orange trees, associated with the fruit product. Diseases such as bacterial, viral and fungal diseases can affect plants. One disease transmitted by species of psyllids (a type of insect) is a disease referred to as Huanglongbing (HLB) or citrus greening. Such diseases can cause certain, sometimes higher, levels of bitterness or other characteristics. Other diseases or conditions can cause increased bitterness, as well, such that increased bitterness can refer to a higher than average or acceptable bitterness level. Processes or treatments can also result in a fruit product that is a candidate for debittering and/or deacidifying methods. Several types of HLB exist, and one or more types can affect one or more plants, thereby causing a change in bitterness or acidity of fruit products, as compared to earlier products or portions of a product. In one example, psyllid populations have grown in Florida and instances of infected plant material and/or symptoms of HLB have been detected.

As indicated, diseases such as HLB and/or other conditions, such as seasonal changes or natural occurrences, can affect bitterness or other flavor criteria, pH levels, and the components, or ratios of components, of a fruit product. HLB and other conditions can also be causes of clouded product, including full-cloud product, and pulp levels or other components of fruit product affecting a Brix level at various points of production. Such effects of greening diseases or other conditions can be addressed with debittering and/or deacidifying techniques described herein. These effects, including the amount or level of cloud or pulp, can be addressed at any point during processing or preparing a juice product for consumption, and changes in the supply or currently-processed batch can be dynamically addressed as discussed below.

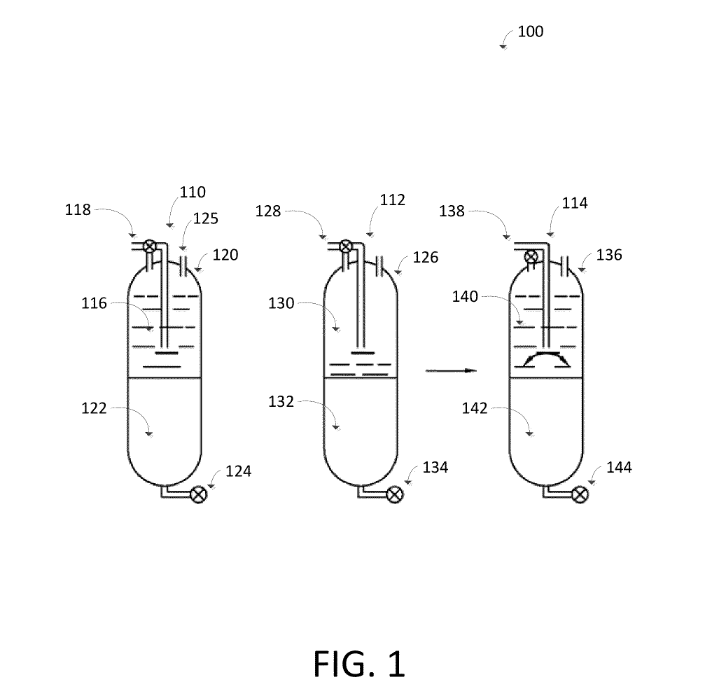

Deacidifying and debittering processes can be performed separately or in combination, according to uses involving more than one process in parallel or occurring concurrently. FIG. 1 shows an exemplary depiction 100 of one or more vessels (110, 112, 114) that can be used within a plant or manufacturing facility, for example, to treat fruit material. As shown in FIG. 1, fruit material 116 such as fruit juice (e.g., orange juice and pulp material) can enter a vessel 110 through an inline 118. The fruit material 116 resides inside the vessel 110 in a compartment 120, such as a compartment 120 that comprises about the top half of vessel 110. The other portion of vessel 110 may be a resin bed 122, which the fruit material 116 is exposed to during processing inside vessel 110. Portions of the resin bed 122, such as rinses or detergents or regeneration materials (including caustic solutions) can be drained using outlet 124 throughout the process, and water or other material can exit through outlet 124 after rinsing or other steps. An outgoing line 125 can be used to move fruit material 116 or other substances from vessel 110 to another vessel, such as vessel 112 in FIG. 1.

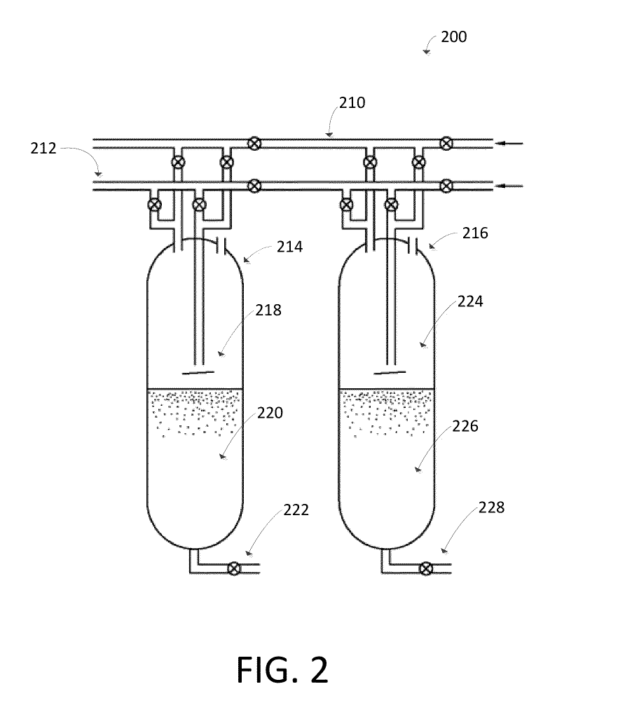

FIG. 2 shows another exemplary arrangement 200 of components in a system for deacidifying and/or debittering. FIG. 2 shown two lines 210, 212 connected to vessels 214, 216 in order to supply and/or remove fruit material during processing. Fruit material can be moved through lines 210, 212, in more than one direction, depending on the need for additional processing in either vessel 214 or 216, or due to reaching a point where processing is complete. Space 218 in vessel 214 can be used for a first treatment or process, such as a resin treatment to lower acid or lower bitterness levels, or to affect cloud level. A bed 220 can use energized material, such as material treated with caustic chemicals, to then treat a fruit material in space 218. Aspects of the bed 220, such as rinses or broken up resin material, can be removed using drain 222 of vessel 214. Similarly, in space 224 in vessel 216, a bed 226 can be used to change the chemical characteristics of fruit material, and waste or cleaning materials can exit using drain 228 of vessel 216. The bed 220 in vessel 214 can be cleaned, reclassified and/or regenerated while fruit material is in space 224, and bed 226 in vessel 216 can be treated or energized while fruit material is in space 218. When one or more spaces 218, 224 are available, then beds 220, 226 can be transferred or regenerated.

Vessel 112 may serve a different purpose than vessel 110 (for example, one or more vessels at a time may be used for deacidifying or debittering and/or to affect the cloud level or sweetness). Vessel 112 also has a compartment 126 in the upper portion of the vessel, in the example shown in FIG. 1, which could be in any location within a vessel 112. When inline 128 is used to distribute fruit material 130 to vessel 112, then the substance in compartment 132, such as resin material, is exposed to the fruit material 130. In some cases, water or other solutions have been exposed to compartment 132 prior to the introduction of fruit material 130. Again, portions of a resin bed or other outputs can be collected using drain 134 of vessel 112.

In embodiments, compartment 136 of vessel 114 can be used to receive, via inline 138, fruit material 140. Fruit material 140 can be exposed to bed 142, which can include regenerated resin that was prepared during treatment of the fruit material in a prior vessel, such as vessel 112. Drain 144 can be used to remove material from bed 142 before or after treating fruit material 140 with bed 142. Fruit material in the three vessels shown as exemplary vessels 110, 112, 114 can be continuously transferred and processed, while simultaneously the resin beds, such as resin bed 122, are treated and/or regenerated when available (when fruit material is in other or alternating vessels). Two vessels 110, 112 can be used and alternated, with regeneration occurring in one vessel at all or most times, to process fruit material 116, 130, in embodiments.

Columns or vessels, or compartments inside either, can be any shape or size, and are not intended to be limited by the illustration provided. In embodiments, one column or more than two columns or vessels can be used, and their connections or interfaces can be shaped or structured in any manner to allow exposure of fruit product to substances such as resin, including almost filled columns, partially filled vessels or columns, and/or other shapes of components such as vessels or components inside of columns or vessels.

Pre-processing, as shown at 510, could include filtration or ultrafiltration, centrifuging or other processing techniques performed prior to (or, in embodiments, after) a deacidification process and/or a debittering process. Columns or vessels can be filled or partially-filled with ion-exchange resin beds, beads or matrices. The timing and/or triggers for transferring these resin substances can be used to control or optimize the fruit products, such as through alternating regeneration with time spent exposed to a fruit product, so as to more quickly or efficiently perform the ion-exchanges overall.

A deacidification portion 520 can be used to achieve a pH above a certain amount or threshold, such as greater than 5.0 or 5.4, or another value, which has been determined to be suitable or preferable for to consumers of juice products. Filtration can be used prior to or as part of a deacidification process. A minimum Brix value can be set as a desired value during or after the process, and/or a Brix to acid ratio value can be used. Ingredients can be added or removed from a fruit product during the processing. A resin material, or a combination or resin materials and other materials, can be used, such that ions are exchanges when a fruit product is exposed to the material(s). In an embodiment, weak base anion resins are used. Various resin materials can be implemented in different embodiments. Reading of pH values can be taken at various times, and graphs can show an increase in pH values over time based on embodiments.

A debittering portion 540 can include one or more debittering resin materials. In embodiments, ion-exchange resin material including, for example, a cross-linked copolymer resin or beads, or adsorbents are used. Resin materials can include or comprise polymeric adsorbents. One or more substances alone or in combination can be used to debitter fruit product, as described in more detail below, by, for example, exposing fruit product to a resin structure, bed, or material(s). A fruit product that has been processed according to a debittering portion 540 and/or a deacidification portion 520 can be referred to as clarified, debittered, deacidified or low-acid fruit product or juice.

Although an example is shown with more than one column, it should be understood that this simplified representation does not encompass all variations and structures contemplated as embodying the methods and processes described here. For example, more than one vessel can be used within one column for deacidification, debittering or both (simultaneously or alternately). More than one system or processing area can exist within a column or vessel, and, in some cases, the resin associated with a column or vessel is transferred to effectuate a change in the same processing space or location.

Columns, vessels or compartments can contain or be constructed of resin substrates or substances, such as beads or matrices. The resin materials can be used in parallel or used alternately to facilitate regeneration. For example, a column or a set of one or more vessels can run continuously by using more than one processing area, or alternate areas or resin such that a process occurs in one area while regeneration occurs in another. The transfer of resin or other substrates before or during a process can lower water or other needs, such that less water must be added to a fruit product during processing. Two or more processing areas can be used to alternately treat (e.g., debitter or deacidify) a fruit product, or other processing can alternately be used, while regeneration is occurring, as well.

Exchange materials, such as substrates, matrices or beds, including but not limited to polymeric adsorbents, can be mixed or otherwise used in combination within a column or vessel, or as transferred with respect to a column or vessel, to allow more than one processing or regeneration task to take place. A regeneration process can be used to more efficiently utilize processing areas, such as alternating processing areas, by regenerating or recharging resins for continued operation. In an embodiment, regeneration can be used to avoid contamination, such as by controlling the timing and location of regeneration such that batches or portions of fruit product are kept and treated separately from each other. In embodiments, regeneration can be used to avoid contamination of one type or quality of fruit product supply by another type or quality of supply. In some cases, resin material is transferred from a column or vessel for or during regeneration, such that other processes or resin material can be exposed to the fruit product, thereby avoiding additional water or other additives.

In one example, a first resin step can be followed by a recharging or regeneration step or steps, followed by a second resin step in the same vessel or column. A first area of a vessel or column may be used for a debittering step, for example, while a regeneration process takes place in another area or with a secondary resin bed that has been transferred. Steps may be taken to break-up resin, followed by steps to vent a line and transfer resin, and then a later return of resin can be used. In embodiments, this transferring of resin can decrease or eliminate the need to add water at certain points during a process.

A plant or structure for deacidifying and/or debittering can include a skid with two adsorption vessels mounted on it, along with control cabinet(s), regenerant measure tank(s) and metering pumps. Also, caustic soda reuse recovery tank(s), reuse caustic soda injection pump(s), water pressure regulator(s) and control equipment, and fluid measuring and control devices can be included, which can make up or be a part of a “main skid.” An upper framework can hold a resin cleaning system, a resin transfer tank and/or a low pressure air blower. Parts of a plant in contact with juice or caustic soda can be stainless steel, and manholes and sight glasses can be provided in resin vessels.

A “twin-alternating” construction or method can be used with the two (or more) adsorption vessels or columns One vessel or processing area can treat juice while another is regenerating, allowing for continuous processing until, for example, cleaning or maintenance, such as cleaning-in-place (CIP), is required. A cycle for each vessel can include sweetening-on (displacing water in the vessel with juice) until the vessel outlet concentration increases to around 1° Brix. The treated juice can then be collected. Juice processing can continue for a predetermined volume before sweetening-off (displacing juice in the vessel with water), rinsing, backwash and/or resin transfer to the cleaning station. A process vessel can be returned for regeneration with dilute caustic soda, rinsing with dilute phosphoric acid, and/or rinsing in readiness for the next process cycle.

A plant or processing system can be automated. Control(s) can be provided and/or housed in a cabinet, along with all other electrical and pneumatic controls. Embodiments include computer-readable storage media storing instructions that cause one or more devices, such as computing devices, to execute, enable and/or perform steps and processes described herein. An operator interface can be provided, and operational data, plant status and control functions can be accessed. A juice pump is powered and controlled from the control cabinet, for example. Manual over-ride can be provided to allow independent operator control of any valve or motor through touch-sensitive controls or other input mechanisms. Lockouts can prevent accidental improper operation, which could damage a product or machine.

Double block and bleed valves (such as butterfly leakage valves) can be used to prevent or decrease contamination of products with regenerant from the regenerating vessel. The volume of juice to be treated per cycle and process flow rate can be preset and varied by the operator. One or more processed volumes and flow rates can be displayed. Additional instruments allow for display of flow rates of water and caustic percent strength and rinse down conductivity. All flows can be monitored and alarmed.

Precise control of the flow rates can be provided for juice, rinse and backwash water. Regeneration of the processing resins can be carried out at approximately 3.5 to 5.5 hourly intervals. Caustic soda or other substances or chemicals can be used to regenerate a resin, such as a polymer resin. The resin may be briefly contacted with phosphoric acid to minimize residual sodium. For example, one or more liquids or solutions, 45-50% caustic soda and/or 75-85% phosphoric acid can be pumped and diluted on-line at a correct rate by metering pumps from pre-measure tanks mounted on the skid. In embodiments, other amounts and percentages, and combinations of substances, can be used to regenerate a resin or resin material.

The amount of regenerant required can be approximately the same per regeneration or vary. The quantities of chemicals used in this example below are given in units per 1,000 gallon single strength juice and are based on an approximate batch volume of 9,200 gallons, and include caustic savings. CIP may require additional caustic soda. In this example, 8.3 lbs of caustic soda (NaOH) 100%, 1.4 gallons of (caustic soda 50% w/w) and 0.48 gallons of phosphoric acid 75% w/w could be used. Note: Chemical solution may be expressed as w/w or v/v. w/w is weight/weight and is the percentage of substances by weight. v/v is volume/volume and is used when two liquids are mixed together. Preferably, the phosphoric acid is “food grade” and free from additives. The caustic soda should not contain surfactants or sequesterants or other additives found in “cleaning” grade caustic soda. Any levels of contaminants in a batch of caustic soda should preferably not exceed certain levels, including contaminants such as iron, heavy metals, mercury, chlorates, silicates, suspended solids, sodium carbonate, sodium chloride, and/or sodium sulfate, such as predetermined limits of parts per million.

For the debittering process, a machine or structure(s) can include a system which will save the second half of the regenerant (e.g., a caustic soda regenerant) and use it again for the first half of the next regeneration. In this way, fresh caustic soda is only required for the second half of the regeneration. Caustic soda consumption can be reduced by about 40%. The system can consist of a stainless steel tank, pump, valves, pipes, level control switches, Programmable Logic Controller (PLC) control hardware and software, and it can be integrated on or with the skid of a debittering plant or structure.

In some cases, a column or vessel, such as part of a plant, may be idle or shut down. Pipes, process vessels and/or resin beds can be filled with 2% caustic soda to maintain a plant in a biostatic condition. This process can be automatic and initiated by pressing a button on a console, such as a “Lay-Up” button on a control console. A complete rinsing can be achieved before commencing or re-commending processing by pressing another button, such as a “Lay-Up Recover” button. The quantities for a lay-up and lay-up recovery can be, for example, 572 lbs of caustic soda (NaOH) 100%, 90 gallons of (caustic soda 50% w/w), and/or 6.5-8 gallons of phosphoric acid 75% w/w. Citric acid can be used for resin rinsing during commissioning.

Equipment or systems can be designed to process full cloud citrus juices or extracts so that there is minimal change to the appearance and characteristics of fruit products, including consumer products. To prevent blocking of the resin beds during a process cycle, it is preferable to reduce the pulp content to not more than 1.0% v/v. A feature or aspect of certain debittering systems can be the ability to handle occasional pulp levels of more than 1.0% v/v for a duration. If excessive pulp enters the bed, the resin will be cleaned during the following resin transfer and/or cleaning and regeneration cycle. Pulp reduction can be accomplished by centrifuging. Centrifuging efficiency may be improved if a fruit product or juice is hot.

In an embodiment, a debittering resin is used. In this example, 90-95% of “soluble” limonin can be removed from the portion of juice passing through a resin, for example when averaged over a complete process cycle, or more or less depending on conditions and settings. One taste threshold level for limonin is 4-6 ppm (parts per million). For limonin reduction, the juice can be heat stabilized before debittering to obtain increased limonin development from the non-bitter limonoate A-ring lactone. In an exemplary process, a debittering resin is regenerated with caustic soda (sodium hydroxide, NaOH) rinsed with water and acid rinsed with phosphoric acid to remove residual sodium. One or more combinations of resins may be used together for the same or different functions. During service, small losses of resin fines may occur when resin washed.

In some exemplary embodiments, a plant or other structure contains water and, when processing begins, juice pushes water through a bed of resin and out to drain until an appropriate volume has been reached. The flow can then be switched to the product tank, thus, collecting processed juice. This can be referred to as “sweeten-on.” When a plant capacity or other volume or condition is reached, juice is pushed out of the bed with water, in embodiments. Juice can be pushed to a product tank. After an appropriate volume, a flow can switch to an effluent drain, which can reduce the ingress of water in a product. This can be called “sweeten-off.” “Sweet-water” can refer to a mixture of juice and water that can occur at an interface during sweeten-on and sweeten-off.

Methods and systems described herein can be utilized for processing both frozen concentrated orange juice (FCOJ) and not-from-concentrate (NFC) juice. For FCOJ, a volume of sweet-water (from both “sweeten-on” and “sweeten-off”) can be optimized to ensure a minimum or reduced amount of juice is lost during one or more steps. Preferably, in a correctly adjusted embodiment, juice losses at each cycle will be up to approximately 1%. For NFC juice, one or more structures can be manufactured with enhancement(s) to minimize a volume of water added to a product at the start and end of one or more process cycles.

In embodiments, a supply of clarified or pulp-reduced juice at a flow rate of 30 to 50 gpm (gallons per minute), at a pressure to be approximately 45 PSIG (pounds per square inch gauge), and preferably, in embodiments, not greater than that amount or a variation of that amount. A feed pump can be stainless steel. A maximum height of a treated juice tank, in embodiments, is not greater than 5 m higher than a base of a debittering plant or structure (i.e. not more than 8 PSIG), for example.

Water for regenerating and rinsing resin preferably meets minimum standards, such as World Health Organization standards, for potable water. Water should preferably be softened for some or all steps except for a final rinse. Clean product concentrate (free from microbiological contamination, entrained soluble, and insoluble solids) is recommended. In an embodiment, regenerant water is 120 to 140° F. Water associated with the debittering steps or plant structures is preferably provided by a pump capable of 100 gpm, which can be operated with a variable speed drive (VSD) and pressure transmitter, to supply a constant pressure of 45 PSIG, in an exemplary embodiment. In embodiments, speed and/or other controls for a VSD can be through or with an Ethernet card.

Water at 140 to 160° F. can be provided for resin rinsing during commissioning. In one example, structures and machinery are designed to meet local electricity supply requirements, such as a 64 amp maximum capacity supply. Requirements can include, for example: 3 phase 440 to 460 Volt 60 Hz, +Earth; 110 to 120 Volt 60 Hz+Neutral; and control voltages (PLC I/O and some instruments) which can be 24 Vdc and supplied from within a control cabinet.

In embodiments, compressed air at 85-120 PSIG can be used or required for actuating one or more ¼ turn actuator(s) on one or more process valves. Air consumption can be estimated or intended to be at 1 normal ft³/hr. Low-pressure air for cleaning the resin bed can be supplied from a plant or structure's own blower or other mechanisms. Storage tanks for bulk regenerants can be used, or other suitable installations or structures large enough to take account of delivery schedules and/or other usage. The bulk tank outlet is at least 5 ft above the level of the floor where a plant or structure is located, in an embodiment. In some cases, if necessary, due to conditions, provision can be made in a caustic tank and/or on pipelines to a plant to warm a caustic sufficiently to avoid freezing.

In embodiments, with respect to effluent, steps can include draining to an acceptable or predetermined highly-colored or colored caustic solution, for example a solution up to 3% concentration, then a rinse water step or process and a backwash water process at up to 160 gpm. In embodiments, this will preferably be an open drain located in the floor, behind a plant or structure, with no back pressure towards a plant or structure. Dimensions of an exemplary plant, such as a fruit product plant (in embodiments a citrus plant with deacidifying and/or debittering capabilities), excluding one or more caustic save systems or areas, can be approximately 19′7″ in length, 7′5″ in depth, and 21′4″ in height. In other embodiments, other dimensions of greater or lesser amount can be used. In some cases, it is recommended that a space of at least 3′6″ that is free of interference should be left around an installed plant or structure (including the top) to enable operation and maintenance.

A plant or system is capable of expansion to increase, such as to double (or more), its processing capacity. Installation of an additional skid with two process vessels configured to share the existing resin transfer and washing system may enable a plant to process up to 90 gpm or more.

The steps and processes described herein can comprise one or components that provide structure or conditions for performing the step(s) and processes. One or more components or steps may be automated or triggered automatically, and various controls can manage or regulate the components or steps. Any part or portion of the steps described here can comprise a method for processing a fruit product, alone or in combination with any other part or portion. As stated, debittering and deacidifying processes can be used alone or in combination with each other, to treat different or overlapping fruit product. Variations of these steps can be understood to encompass ranges of temperatures and other conditions. Variations may be used to address differences in the fruit supply or to encompass other quantities or end-product goals. Safety or regulatory concerns and disease-correcting techniques can be used to adjust the processes.

In embodiments, one or more processes can be used to reduce fruit defects and/or resulting characteristics of fruit defects, such as abnormal acid levels or excess bitter compounds, such as those caused by HLB and other debilitating diseases. Resin systems can be combined to enable or enhance these process(es). Two or more resin systems or materials can be mixed beds in the same column or columns Combined beds can be used in more than one column. These columns can be in parallel or series, and/or resin systems can be in parallel or series. Conditions such as temperature can enable regeneration to protect products from cross-contamination. Full-cloud or higher cloud fruit product can be handled.

Transfer mechanisms can be used or implemented to produce fruit juice products without adding water or while adding less water, which can be used if a Brix level is low or desired to be adjusted. Plants or structures can be set up or ordered to debitter only, to deacidify only, or to do both concurrently by installing two or more types of resin in one process vessel or column Two vessels can be used to provide continuous operation, with one on-line and processing while another regenerates, in a twin-alternating type-operation.

Proportional, integral and derivative set points are indicative only. Once a plant is commissioned these may change depending on local operating factors. The steps below are examples only of a debittering process, includes general processes that can be used alone or in combination with each other and deacidification and other treatments. Variations of steps can be used to achieve the purposes described herein and to process fruit product as disclosed.

Methods for treating a fruit product can include reducing the acid level or the bitterness level, if some or all of the fruit product includes material associated with a source that is affected by a disease, such as fruit associated with a plant. In an example, the fruit is orange fruit and the fruit product or material can include juice or pulp, and one or more sources of the fruit material is associated with a greening disease such as Huanglongbing, another disease that can be transmitted by a psyllid, and/or another bacterial, viral or fungal disease. In some cases, other conditions besides greening diseases can cause or exacerbate acidity or bitterness levels outside of acceptable ranges, such as environmental conditions (drought, pollution) or certain fertilizers, herbicides or other substances.

In some cases, the disease or condition of the fruit product is not detected immediately or upon inspection when a fruit is still attached to a plant. Sometimes, later detection of acidity and bitterness levels is required to determine the likelihood or presence of fruit material affected by the disease or condition. The cloud level of a fruit material can also be measured or inspected in order to determine treatments with one or more resins, including the amount of time of exposure to one or more resins. The use of one or more resins, including to deacidify and/or debitter fruit material, such as fruit juices, can be performed with an end-goal of a particular acidity level, bitterness level, and/or cloudiness level. The timing and any intermediate testing are designed to reach particular levels of the characteristics, in an embodiment.

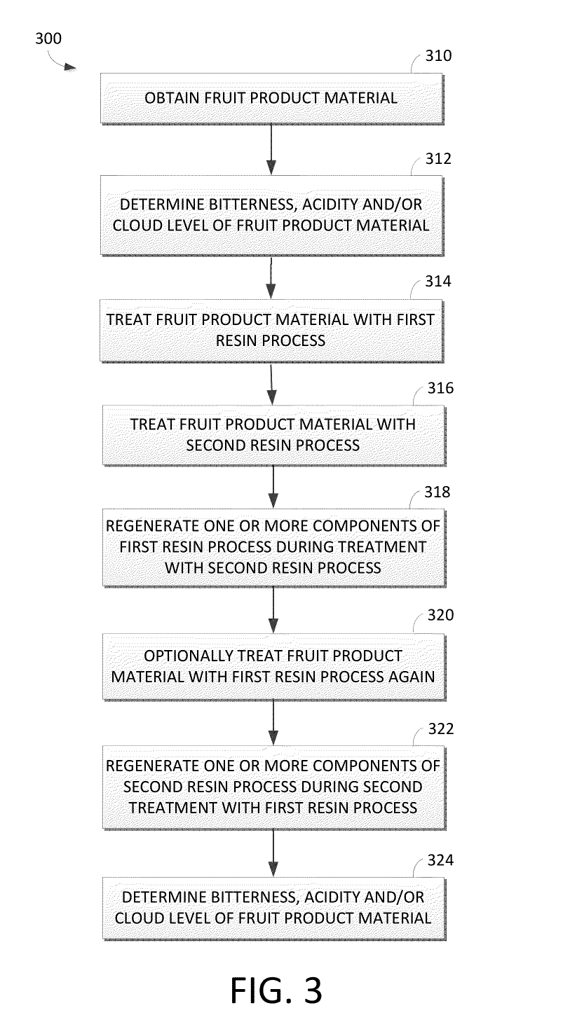

FIG. 3 shows a process 300 for treating fruit material, such as fruit material 116 in FIG. 1. An exemplary process 300 can begin with obtaining fruit material. In embodiments, the fruit material 116 includes material from one or more sources, such as plants or growing areas, that have been affected by a greening disease or other cause of excess bitterness. Fruit material 116 can be treated for acidity due to naturally occurring acidity levels or taste preferences, and fruit material 116 can be treated for bitterness due to greening disease(s) or other causes, such as early-harvested fruit products or conditions such as drought. A cloud level of fruit material 116 can also be treated or changed during processing. As shown at 312, the bitterness, acidity and/or cloud level of fruit product material is determined. At 314, fruit product material is treated with a first resin process, such as exposure to a resin bed, such as resin bed 122 in FIG. 1.

The fruit material may be treated with a second resin process, such as exposure to a second resin bed (e.g., bed 132 in vessel 122 in FIG. 1), as shown at 316. Components of the first resin process can be regenerated during treatment by the second resin process (step 318), and fruit material can optionally be treated by the first resin process again (step 320). Components of the second resin process can be regenerated during treatment with the first resin process, as shown at step 322. As shown at 324, the levels of bitterness, acidity and/or cloud level can again be determined, at a point of removal or throughout the process, to change treatments in accordance with dynamic levels of one or more chemical characteristics of fruit product material.

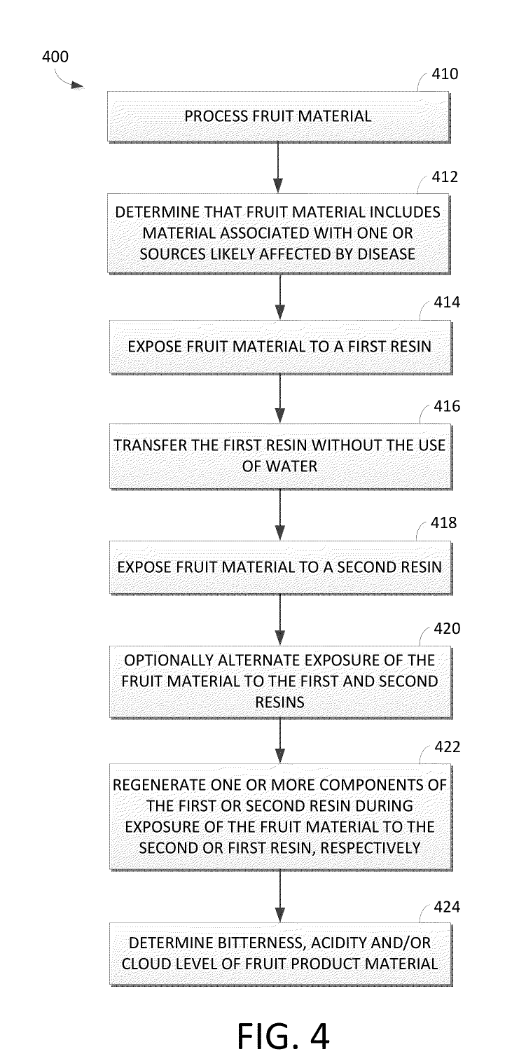

Another illustrative process 400 is shown in FIG. 4, beginning with processing fruit material at 410, and determining the fruit material includes material associated with sources likely affected by a disease, such as a bacterial disease that results in higher bitterness levels, at 412. Fruit material, such as fruit material 116 in FIG. 1, is exposed to a first resin at 414, followed by transfer of the resin (e.g., resin bed 122 in FIG. 1) without the use of water at 416, in certain embodiments. Fruit material is exposed to a second resin (at 418) and can be alternately exposed to the first and second resins (at 420). During treatment with one resin, a second resin material or components thereof may be regenerated, as shown at step 422. The bitterness level, the acidity level or the cloud level can be determined, as shown at 424.

In an example, one or more resins may be used as described herein to treat a fruit product that is determined to have a cloud level above a first level, or a fruit product with a full cloud level. It is possible for fruit matter, or material that is at least part fruit matter when it is being treated, to have a dynamic cloud level. In some cases, the treatment for cloud level can be adjusted in response to observed changes in cloud level. Similar adjustments can be made for dynamic acidity levels and/or bitterness levels, or any other characteristic sought to be controlled in the material. Components or ingredients may be added through titration or other methods as feedback is monitored for adjustments in the levels.

For instance, if one or more sources of material changes during processing, such as one or more fruits or fruit matter from different plants or plots of land or suppliers, then adjustments may be expected as the material changes. Other factors can cause changes in levels, such as the placement of material during transport over time and/or its exposure to oxygen or other elements. In other cases, the performance level of one or more resin treatments could increase or decrease (due to, for example, exhaustion of components and/or success of regeneration, respectively), also necessitating changes in treatment levels.

Embodiments of technology described herein can include one or more systems for handling material, such as fruit material, using two or more resin processes. The handling adjusts an acidity level and/or a bitterness level, in embodiments. The first resin process can be associated with a first vessel and the second resin process can be associated with a second vessel. In other cases, the second resin process is associated with two or more vessels. Each vessel can include one or more substances capable of interacting with said fruit material.

In embodiments, the first set of one or more substances includes one or more functional groups. The functional groups can interact with the fruit or other material and absorb or bond with molecules that will cause an increase or decrease in acidity or bitterness or cloud level. Organic or inorganic resin material can be used, and resin may be regenerated by exposing it to another substance that will reverse or undo the effects of the fruit material on the resin. For example, the functional groups may bond with hydrogen ions or other molecules during exposure to a fruit material, and the functional groups may disassociate or break bonds with the hydrogen or other molecules upon exposure to a different material. In other cases, time or natural regeneration methods can be used, or resin material can be implemented for different and alternating functions in order to reverse effects. In other words, a resin treatment could be implemented with one fruit material to cause one effect, and then implemented with another fruit material to cause the reverse effect.

Functional groups can be, for example, strongly acidic, strongly basic, weakly acidic, and weakly basic. The resin treatment or material can be exposed as a resin bed. In some cases, a first and second resin treatment can include one or more of the same substances. The first resin treatment can be performed while the second resin process is prepared, including while the second resin process is regenerated. The first and second resin treatments can occur in the same vessel or column, which can include one or more mixed-resin beds. The same space can be used for exposure to a first resin treatment and a second resin treatment. In embodiments, the resin material is transferred, which can be accomplished without the use of additional water or water for the purpose of transferring resin. The timing of two or more resin treatments, and/or the transfer of resin material, can be controlled or programmed and based on feedback or measurements of dynamic levels of acidity, bitterness or cloud level.

The application of each resin treatment may be alternated, for example, and the regeneration of the resin treatment that is not in use can be alternated, as well, such that two resin beds are continuously being used for treatment or regenerated. In embodiments, a first resin treatment deacidifies the fruit material while a second resin treatment debitters the fruit material. Although reference is made to the fruit material during the processes described herein, it should be understood that the fruit material can be adjusted in content or composition throughout the process as other ingredients, raw materials or substances are added, or as conditions change (such as heat causing loss of water). The continuous addition of new fruit material and continuous removal of longer-processed fruit material is still the fruit material as understood herein, which can be treated with one or more resin treatments. In other words, the actual fruit material may be changing over time as it is processed, causing dynamic values of various levels in the material due to on-going processing. In other cases, an entire vat or batch may be static or processed at once with little to no carryover between designated batches.

One vessel can be used for deacidifying and another vessel can be used for debittering, in embodiments. Fruit material could be processed through the first vessel and then the second vessel, which could be repeated one or more times until the desired levels of acidity and bitterness and/or cloud level are achieved. In some cases, four vessels can be used to alternate deacidifying and debittering, or any number of vessels to control the availability of the appropriate resin beds at the right level or regeneration, for example, to maximize the amount of fruit material processed at one time or over a period of time. Regeneration can be used to reduce or eliminate contamination in resin beds. Therefore, in some cases, treatments of fruit material are controlled in order to achieve resin beds with sufficient regeneration to reduce or avoid contamination.

Regeneration effects can be accomplished by adding a material or changing a condition associated with a resin bed, in some cases while a fruit material is being treated by one or more other resin treatments. For example, water or solutions or gases, or temperature or pressure changes, can be used to cause or excel regeneration, while fruit material is being treated by another resin treatment or between all treatments. The resetting of components of the system, while powering off a system or during a manual reset or an overnight period, can cause regeneration to begin or be triggered.

An amount of time or processing with a substance can accomplish regeneration back to base level amounts, in embodiments. A set amount of time can be provided that will result in regeneration. In some cases, regeneration may occur after a sufficient waiting period. In other cases, in order to achieve regeneration by a certain point in time (such as the beginning of another shift or batch process), a time will be selected or predetermined, and the system will cause the other conditions necessary to achieve regeneration by that time, in some cases with the least amount of processing or substances, including water, necessary to achieve regeneration by a selected time.

A chemical characteristic of a juice or fruit material can be different from one batch or source of fruit or other products to another. The difference in the chemical characteristic may be detected as fruit material is being received or processed, or it may be determined in advance and designated for different treatment. In embodiments, a chemical change is registered during processing and a current or upcoming resin treatment is planned or adjusted in response to the difference in the chemical characteristic. For example, the amount of hydroxide ions or the amount of hydrogen ions (or citric acid or ascorbic acid) can be detected and/or responded to with specific treatments, such as certain resin bed compositions or exposure times, or treatments until specific parameters are reached, such as deacidifying or debittering to acceptable levels. Three or more different resin treatments can be used, as alternating treatments or successive treatment options based on initial conditions or dynamic readings.

A portion of one batch may be divided among vessels or treatment areas, such that both deacidifying and debittering occur simultaneously on different portions of the fruit material. The portions may continuously move between vessels according to timing or levels of chemical characteristics, for example. New fruit material may be added during the batch, as portions of the batch undergo two types of resin treatments, and portions of the fruit material may be removed during the batch due to obtaining certain levels or for other reasons (e.g., taste preference). The fruit material can be a fruit juice, such as orange or another citrus fruit, or another type of fruit, or a blend of multiple fruit and/or vegetable juices that may or may not have other substances added (for processing purposes or otherwise).

It will be understood by those of ordinary skill in the art that the specific values, parameters and order of steps shown in the exemplary methods described above and below are not meant to limit the scope of embodiments of the present invention in any way and, in fact, the steps may occur in a variety of different sequences within embodiments hereof and may include less or more steps than those illustrated herein. Any and all such variations, and any combination thereof, are contemplated to be within the scope of embodiments of the present invention.

Exemplary steps of one or more processes disclosed herein are listed in Table 1, below.

TABLE 1
Exemplary steps utilized in certain deacidifying
and/or debittering processes.

| | |
|---|---|
| Step 0 | “Reset” |
| Step 1 | “Stand by” |
| Step 2 | “Refill Head Space” |
| Step 3 | “Displace Head Space” |
| Step 4 | “Fill Head Space” |
| Step 5 | “Wait - Sweet Water” |
| Step 7 | “Sweeten On to Drain (Sweet Water)” |
| Step 8 | “Wait - Sweet Water Tank” |
| Step 9 | “Sweeten On to Sweet Water Tank” |
| Step 10 | “Sweeten On to Drain” |
| Step 11 | “Wait - For other vessel” |
| Step 12 | “Process” |
| Step 13 | “Rinse Vessel 2 (Last Batch)” |
| Step 14 | “Wait - Other Vessel in Standby” |
| Step 15 | “Sweeten Off Inlet” |
| Step 16 | “Displace Head Space” |
| Step 21 | “Refill Head Space” |
| Step 22 | “Sweeten Off to Sweet Water Tank” |
| Step 24 | “Sweeten Off from Top” |
| Step 25 | “Wait” |
| Step 29 | “Make Up Reuse Caustic Tank” |
| Step 30 | “Air Break Up Resin” |
| Step 32 | “Soda and Air Break Up Resin” |
| Step 33 | “Air Break Up Resin” |
| Step 35 | “Flush Vent Line” |
| Step 36 | “Transfer Resin” |
| Step 37 | “Blow Out Resin” |
| Step 38 | “Flush #1” |
| Step 39 | “Blowout #1” |
| Step 40 | “Flush #2” |
| Step 41 | “Blowout #2” |
| Step 42 | “Flush #3” |
| Step 43 | “Blowout #3” |
| Step 45 | “CIP Vessel” |
| Step 46 | “Blowout #4” |
| Step 47 | “Flush CIP” |
| Step 48 | “Blowout #5” |
| Step 49 | “Vent” |
| Step 50 | “Resin Return” |
| Step 51 | “CIP Screen” |
| Step 52 | “CIP Flush” |
| Step 53 | “Drain Transfer Tank” |
| Step 54 | “Refill Vessel” |
| Step 55 | “Settle #1” |
| Step 56 | “Reclassify” |
| Step 57 | “Drain and Flush V48” |
| Step 58 | “Settle#2” |
| Step 60 | “Reuse Caustic Inject” |
| Step 61 | “Caustic Soda Inject Up” |
| Step 62 | “Rinse Caustic Inject Up Line” |
| Step 63 | “Caustic Inject” |
| Step 64 | “Caustic Inject (No Reuse Caustic)” |
| Step 65 | “Slow Rinse” |
| Step 66 | “Fast Rinse” |
| Step 68 | “Phosphoric Acid Inject” |
| Step 69 | “Flush Acid Line” |
| Step 75 | “Final Rinse” |
| Step 80 | “Layup Up” |
| Step 81 | “Layup Down” |
| Step 82 | “Layup Flush Lines” |
| Step 83 | “Layup Wait” |
| Step 84 | “Layup Hold” |
| Step 90 | “Layup Recover Flush Inlet” |
| Step 91 | “Layup Recover Rinse” |
| Step 93 | “Layup Recover Phosphoric Acid Inject” |
| Step 94 | “Layup Recover Flush Acid Line” |
| Step 99 | “Recover Final Rinse” |
| Step 100 | “Recover Layup Wait Vessel 2” |

One or more of the steps described below can be implemented in embodiments to treat material including fruit matter and/or fruit juice(s). The steps are not required, nor must the steps be performed in conjunction or in the order described below, which is one example of potential steps. A step can be to “Reset,” followed by a “Stand by” step, when the vessel is awaiting instructions. From “Stand by” it is possible to command the vessel to “Process”, “Regenerate” or “Lay Up”.

A first vessel can be filled with water, and a blower (not shown) can push water down to a resin bed level, to lower the interaction of water and juice. A distribution of juice such as fruit material can flow into the vessel and push existing juice through a drain (such as drain 124 in FIG. 1) or an outlet (such as outlet 125 in FIG. 1), where material can be monitored for an increase in Brix. A second vessel can wait or be on standby, and an inlet line (such as inlet line 128 in FIG. 1) can be rinsed with water. One or more blowers can push juice such as fruit material down to the resin bed level. A Brix level is monitored and, once it falls below a low-end level, collection of the product stops, in embodiments.

Before a transfer of resin, such as resin 122 in FIG. 1, a blower may inject air to break apart the resin, and caustic soda may be injected into one or more vessels to assist with or cause the breaking-up of resin. Water may be added or used, and it may be reused, in order to keep resin in liquid or solution form. A water hydraulic action can transfer resin, in embodiments, and resin may be pushed towards an outlet with water and/or vacated with a blower. A cleaning solution can be sprayed or fed into one or more vessels at this point, or after any emptying of resin and/or water, in order to expose all internal surfaces to the cleaning solution, which may be flushed with water afterwards. The vessels may also be cleared with air pressure from the blower. As stated above, any of the steps described herein may be omitted. Any one or more steps may also be repeated, as a set of steps or individually and repeatedly, to accomplish a certain degree of a characteristic, such as acidity, bitterness, cleanliness, emptiness or regeneration.

Resin material can be returned to a vessel from another, temporary storage place or tank, which could be another vessel or space within the same system. A vessel may be reclassified at various points in the process, based on the return of resin material or other conditions. Reclassification can ensure the correct or optimal distribution of resin within a vessel or other space. A solution or water, such as hot water, can be applied to a resin bed prior to a hot caustic injection according to functions selected by controls, such as a button. A resin transfer line, which can be an outlet or drain line (such as line 124 in FIG. 1_), can deliver resin, and it can be flushed and resin allowed to settle before an application of chemicals. Reused or new caustic can be applied followed by water, in embodiments. In some cases, the caustic solution is exposed to resin material for approximately one hour for sufficient regeneration, based on the area, density and other characteristics of the resin beds and/or the caustic solution. Other temperature adjustments or catalysts may affect the regeneration time. An internal timing mechanism can be utilized (not shown) and the caustic solution can be used and/or reused continuously, in an example.

Water can be used to push the caustic solution through a resin bed, in embodiments, and/or to rinse one or more resin beds. Phosphoric acid, in an example, can be used to remove sodium or other material that the resin has collected from any caustic solution. A solution, such as a cleaning-in-place (CIP) solution containing one or more detergents, can be used and flushed from inlet lines. Water can be used to rinse and remove all solutions to a drain and phosphoric acid can again be used to remove collected sodium, in an example. In one embodiment, the remaining chemicals in a resin bed are then rinsed until the conductivity of drain water is approximately 100 to 200 μS/cm above a rinse water standard.

The invention claimed is:

1. A process for treating a fruit product comprising:
reducing one of an acid level or a bitterness level, wherein at least a first portion of said fruit product includes material associated with one or more sources affected by a disease.

2. The process according to claim 1, wherein said disease comprises a Huanglongbing disease.

3. The process according to claim 1, wherein said disease is not detected at the time that said material is in contact with said one or more sources.

4. The system according to claim 1, wherein said process is capable of treating a fruit product, wherein said fruit product includes a cloud level above a first level.

5. The system according to claim 1, wherein said process is capable of treating a fruit product, wherein said fruit product includes a change in a level of one of an acidity, a bitterness, a supplier, a flavor, or a performance level of a resin material.

6. A system for handling a material that includes one or more components from one or more natural sources comprising:
a first resin process associated with a first vessel, wherein the first vessel includes at least one ion-exchange resin, and wherein the first resin process affects a bitterness level of the material.

7. The system according to claim 6, wherein the ion-exchange resin includes a set of one or more substances, wherein said set of one or more substances includes one or more functional groups.

8. The system according to claim 6, wherein the first resin process is performed during a preparation period associated with a second resin process.

9. The system according to claim 8, wherein the preparation period includes regeneration of a component of the second resin process.

10. The system according to claim 9, wherein the second resin process affects an acidity level of the material.

11. The system according to claim 6, wherein a resin material associated with said first resin process is transferred.

12. The system according to claim 6, wherein a continuous operation is provided by alternating the first and second resin processes and alternating a first regeneration associated with the first resin process and a second regeneration associated with the second resin process.

13. The system according to claim 6, wherein said ion-exchange resin includes at least one polymeric adsorbent.

14. The method of claim 6, wherein a set of one or more components associated with said first resin process are regenerated at least in part using a caustic substance.

15. The method of claim 6, wherein a set of one or more components associated with said first resin process are capable of being regenerated to prevent contamination.

16. The method of claim 6, wherein a set of one or more components associated with said first resin process are capable of being regenerated based at least in part on a timing.

17. A method of processing a fruit material comprising:
providing a first processing area, wherein at least some of the fruit material is exposed to a first substance in the first processing area, based on a first bitterness level;
transferring a second substance to the first processing area, such that at least some of the fruit material is exposed to the second substance in said first processing area.

18. The method of claim 17, wherein the first substance includes at least one polymeric adsorbent.

19. The method of claim 17, wherein at lest some of the fruit material is exposed to the second substance based on a second bitterness level.

20. The method of claim 17, wherein at lest some of the fruit material is exposed to the second substance based on an acidity level.
